(19) United States
(12) Patent Application Publication
(10) Pub. No.: US 2009/0108098 A1
(43) Pub. Date: Apr. 30, 2009

(54) Universal sprinkler assembly

(76) Inventor: George Soulakis, Mission Viejo, CA (US)

Correspondence Address: GEORGE SOULAKIS, 25991 SERENATA DRIVE, MISSION VIEJO, CA, 92691-5729, US

(21) Appl. No.: 11/981,001

(22) Filed: Oct. 29, 2007

(51) Int. Cl. B05B 1/00

(52) U.S. Cl. 239/203

(57) ABSTRACT

The riser and spray head of a common lawn sprinkler system are adapted for sprinkling in a plane at an angle to the axis of the riser. A ball and socket assembly is connected between the riser and the spray head with the geometries of the ball and the socket truncated in a related manner to avoid interrupting water flow when an off-axis water delivery is achieved.

### FIELD OF THE INVENTION

This invention relates to sprinkler systems typically used for lawns and vegetation.

### BACKGROUND OF THE INVENTION

Sprinkler systems are commercially available and in common use. Such a system comprises a network of fluid conduits such as PVC pipes connected between a water supply and an arrangement of risers. The risers are fitted with spray head assemblies in both fixed as well as pop-up type sprinklers and are organized to water a specified area when activated.

The riser and spray head assembly in such sprinkler systems remain in fixed vertical position while water is flowing, such that water is delivered in an arc which is generally in a plane with respect to which the riser axis is normal. But frequently an area to be watered is at an angle to the axis of the riser. Thus, there is a need for a sprinkler system which is adjustable to permit water delivery in a plane which is at an angle to the axis of a riser.

### SUMMARY

In accordance with the principles of this invention a truncated hollow ball and socket subassembly is introduced between the top of a riser and the bottom of a spray head or between the spray head and the top of the internal riser (stem) of the pop-up sprinkler to permit the angular position of the spray head to be adjusted with respect to the axis of the riser. The ball and socket are hollow and have their top and bottom geometries respectively, truncated to permit such adjustment while avoiding the disruption of water delivery.

### BRIEF DESCRIPTION OF THE DRAWINGS

FIG. 1 is a cross section view of a ball and socket swivel assembly in accordance with the principles of this invention;

FIG. 2 is a schematic view, partially in cross-section of the assembly of FIG. 1 in relation to a riser and spray head of a conventional sprinkler system;

FIGS. 3 and 4 are cross-section views of the ball and socket components of the assembly of FIGS. 1 and 2; and

FIGS. 5 and 6 are schematic exploded views of commercially available riser and spray head assemblies for use with the swivel assembly in accordance with the principles of this invention.

### DETAILED DESCRIPTION

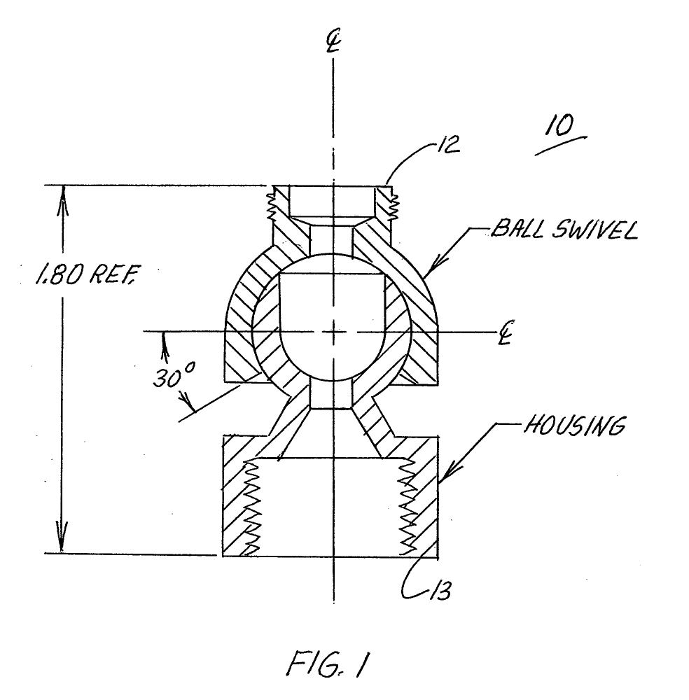

FIG. 1 shows a ball and socket assembly 10 in accordance with the principles of this invention. The assembly is shown with top and bottom ends 12 and 13 (as viewed) having an external and an internal thread for connection to a spray head and to a riser respectively.

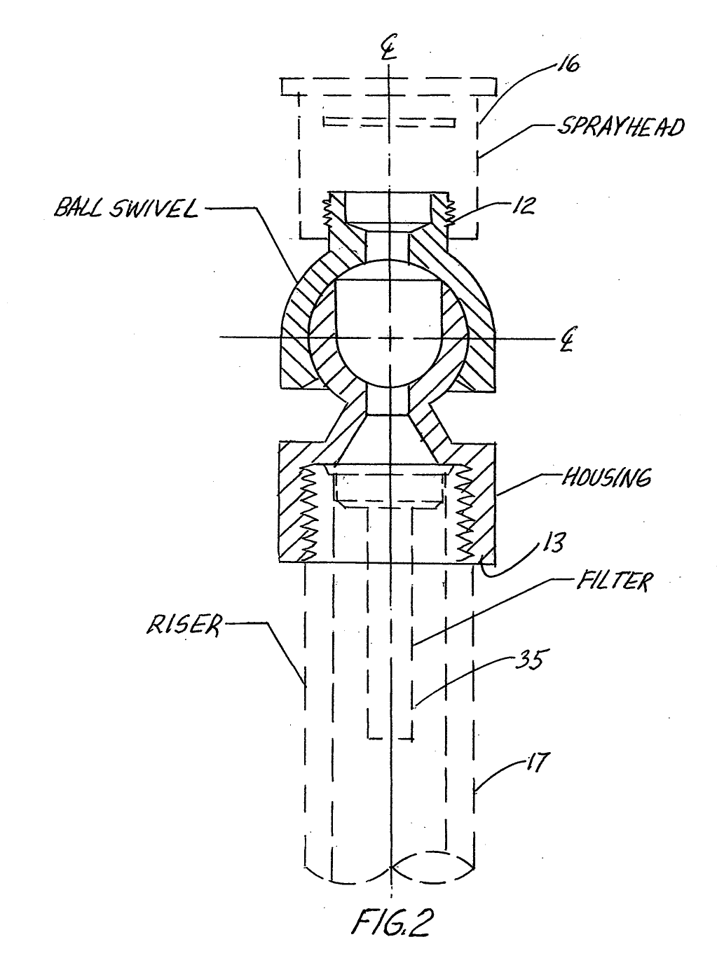

FIG. 2 shows the assembly of FIG. 10 in position between a spray head and a riser in a common sprinkler system configuration. The spray head and the riser are designated 16 and 17 respectively in FIG. 2.

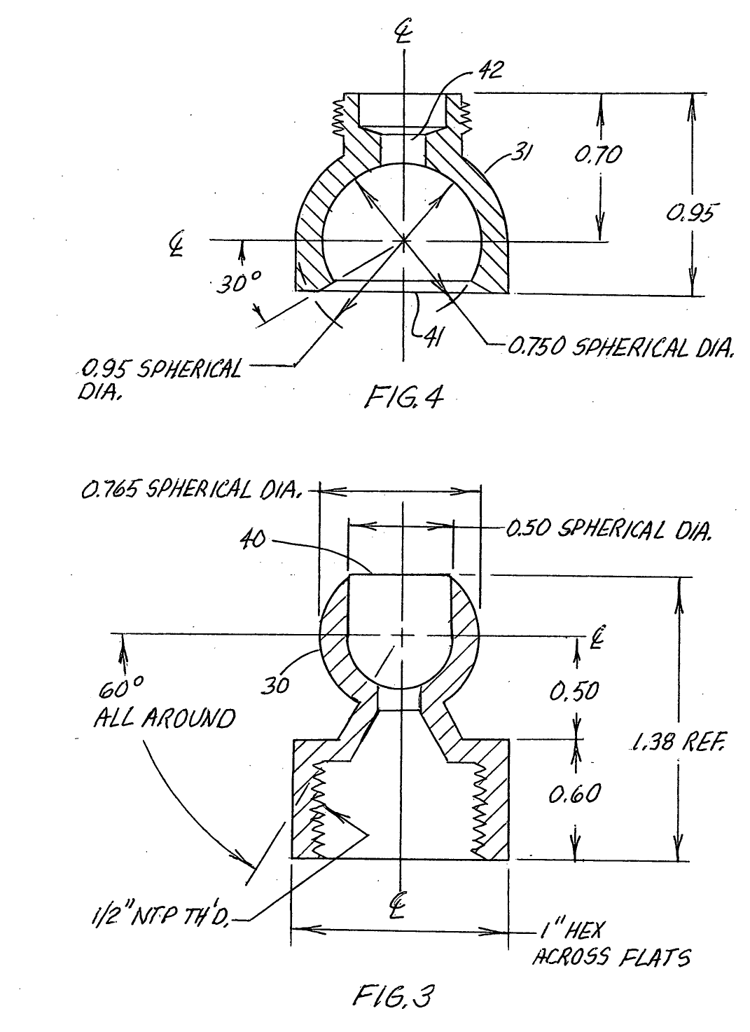

FIGS. 3 and 4 show the ball and socket components of assembly 10 and are designated 30 and 31 respectively. It is to be understood that the outside diameter of the ball and the inside diameter of the socket are chosen to form a water-tight coupling and are constructed of a material such as a thermoplastic to permit adjustment therebetween.

Assembly 10 occupies a position coaxial with the spray head and the riser as is clear from FIG. 2. The axis is designated 33 in FIG. 2. The assembly is hollow to allow for easy fluid flow therethrough, illustratively along the axis. The ball also is configured to receive a filter 35 as seen in FIG. 2.

Both of the ball and the socket have truncated geometries to allow for unobstructed fluid flow when the angle of the socket is off axis. FIGS. 3 and 4 provide illustrative dimensions in inches for the ball and socket respectively. It is clear from the fig's that the top of the ball and the bottom of the socket (as viewed) are truncated as indicated by lines 40 and 41 respectively. The truncated geometry is designed to avoid occluding fluid passage through constriction 42 (shown in FIG. 4) when the socket (31) is reoriented to an off axis position, to permit manual adjustment as one would adjust a joy stick.

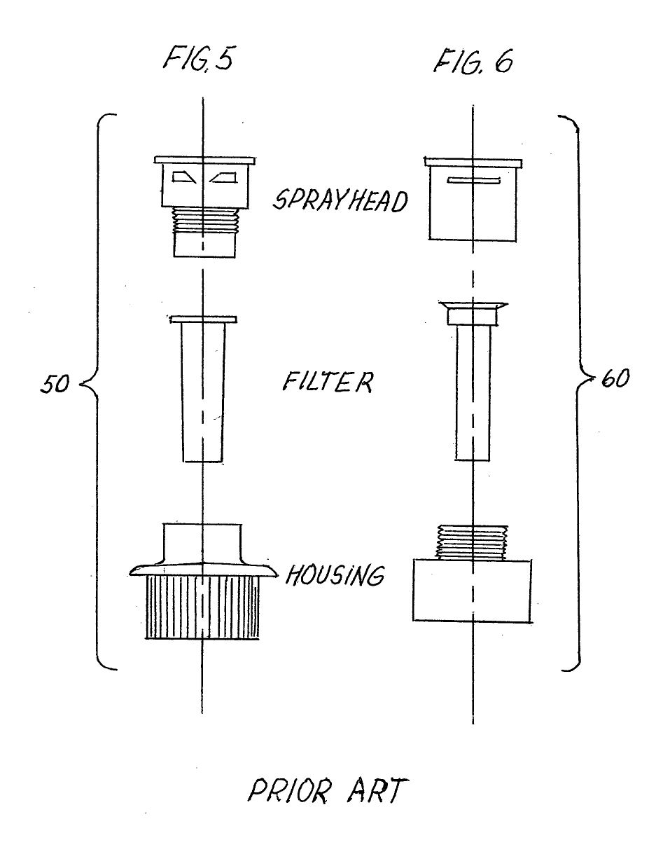

FIGS. 5 and 6 show exploded views of common prior art riser, filter and spray head apparatus 50 and 60 respectively. The configurations in accordance with the principles of this invention as shown in FIGS. 1-4 are adaptable for use with either of the prior art apparatus, housing 13 requiring an internal (not shown) rather than an external thread (as shown) for use with the apparatus of FIG. 5.

What is described herein is merely illustrative of the principles of this invention and various modifications thereof may be devised by those skilled in the art within the spirit and scope of the invention as claimed. For example, the invention has been described in terms of a ball and socket arrangement connected to a riser and to a spray head respectively. The ball and socket could be designed to connect alternatively to the spray head and the riser respectively still within the spirit and scope of the invention. Also, the invention has been described in connection with a riser which is in a fixed vertical position whether the water is on or off. The ball and socket subassembly can be adapted for use with a pop-up riser which is elevated by water pressure by recessing the assembly of FIG. 2 into the canister into which such a riser is normally housed.

What is claimed is:

1. A sprinkler assembly comprising a riser and a spray head, said riser having first and second ends configured for connection to a sprinkler system and to said spray head respectively, said assembly including a hollow swivel ball subassembly, said subassembly being of a geometry to connect to said second end and to said spray head in a manner to allow both angular adjustment of said spray head with respect to the axis of the riser in a manner to allow the unobstructed flow of fluid from said riser to said spray head.

2. An assembly as in claim 1 wherein said hollow swivel ball subassembly comprises first and second components adapted for connection to the second end of the riser and to the spray head respectively, said first component having a first hollow spherical geometry with a first outside diameter, said second component also having a second hollow spherical geometry with an inside diameter sufficiently larger than said first diameter to permit said first and second components to be connected in a manner to permit said first component to be adjustable within said second component.

3. An assembly as in claim 2 wherein each of said first and second components includes an axially aligned hollow conduit for forming a fluid path from said riser to said spray head.

4. A ball swivel sprinkler assembly having first and second ends for connection between a riser and a spray head in a sprinkler system, said assembly comprising a hollow ball and socket and fluid conduits from said riser to said hollow ball and from said socket to said spray head respectively.

5. A ball swivel sprinkler assembly as in claim 4 wherein said hollow ball has a truncated top geometry.

6. A ball swivel sprinkler assembly as in claim 5 wherein said hollow socket has a truncated bottom geometry corresponding to the truncated hollow ball top geometry in a relationship to limit the movement of said ball to avoid occluding fluid passage through the opening allowed by said truncated hollow ball top geometry.
